(19) United States
(12) Patent Application Publication
(10) Pub. No.: US 2025/0005373 A1
(43) Pub. Date: Jan. 2, 2025

(54) PROMPT-BASED MODULAR NETWORK FOR TIME SERIES FEW SHOT TRANSFER

(71) Applicant: NEC Laboratories America, Inc., Princeton, NJ (US)

(72) Inventors: Junxiang Wang, Plainsboro, NJ (US); Wei Cheng, Princeton Junction, NJ (US); LuAn Tang, Cranbury, NJ (US); Haifeng Chen, West Windsor, NJ (US)

(21) Appl. No.: 18/749,887

(22) Filed: Jun. 21, 2024

Related U.S. Application Data
(60) Provisional application No. 63/523,941, filed on Jun. 29, 2023.

(51) Int. Cl. G06N 3/096; G06N 3/0455; G06N 3/084

(52) U.S. Cl. CPC G06N 3/096; G06N 3/0455; G06N 3/084

(57) ABSTRACT

Systems and methods are provided for adapting a model trained from multiple source time-series domains to a target time-series domain, including integrating input data from source time-series domains to pretrain a model with a set of domain-invariant representations, fine-tuning the model by learning prompts specific to each source time-series domain using data from the source time-series domains, and applying instance normalization and segmenting the time-series data into subseries-level normalized patches for the target time-series domain. The normalized patches are fed into a transformer encoder to generate high-dimensional representations of the normalized patches, and a limited number of samples from the target time-series domain are utilized to learn the prompt specific to the target domain. Cosine similarity between the prompt of the target domain and the prompts of source domains is calculated to identify a nearest neighbor prompt, which is utilized for model prediction in the target time-series domain.

### RELATED APPLICATION INFORMATION

This application claims priority to U.S. Provisional App. No. 63/523,941, filed on Jun. 29, 2023, the contents of which is incorporated herein by reference in its entirety.

### BACKGROUND

### Technical Field

The present invention relates to time-series data analysis and model adaptation, and more particularly to a system and method for adapting neural network models trained on multiple source time-series domains to a target time-series domain by integrating domain-specific prompts, utilizing transformer encoders, and dynamically routing connections between sub-networks to achieve accurate predictions and improved model generalization across diverse applications.

### Description of the Related Art

In the field of time-series data analysis, traditional approaches have relied on recurrent neural networks (RNNs), including variations such as Long Short-Term Memory (LSTM) and Gated Recurrent Unit (GRU) networks, to model temporal dependencies within data. These methods are effective in capturing sequential patterns but face significant limitations when applied to scenarios requiring adaptation across diverse time-series domains. The performance of these deep neural networks is hindered by distribution gaps between different time-series domains, leading to suboptimal results when a model trained on one domain is applied to another. This challenge is compounded by the unavailability of domain-specific metadata in real-world applications, which is particularly important for understanding and bridging the distribution gaps. Existing systems also struggle with efficiently adapting models to new domains using limited data samples, thereby necessitating innovative solutions that can automatically learn domain-specific characteristics and facilitate accurate model predictions across varied time-series domains without extensive retraining.

### SUMMARY

In accordance with an embodiment of the present invention, a method is provided for adapting a model trained from multiple source time-series domains to a target time-series domain, including integrating input data from a plurality of source time-series domains to pretrain a model, the model including a set of domain-invariant representations, fine-tuning the pretrained model by learning prompts specific to each source time-series domain using remaining data from the source time-series domains, and applying instance normalization and segmenting the time-series data into subseries-level normalized patches for the target time-series domain. The normalized patches are fed into a transformer encoder to generate high-dimensional representations of the normalized patches, and a limited number of samples from the target time-series domain are utilized to learn the prompt specific to the target domain. A cosine similarity between the prompt of the target domain and the prompts of all source domains is calculated to identify a nearest neighbor prompt, and the nearest neighbor prompt is utilized for model prediction in the target time-series domain.

According to another aspect of the present invention, a system is provided for adapting a model trained from multiple source time-series domains to a target time-series domain. The system includes a memory storing instructions that when executed by a processor device, cause the system to initiate integrating input data from a plurality of source time-series domains to pretrain a model, the model including a set of domain-invariant representations, fine-tuning the pretrained model by learning prompts specific to each source time-series domain using remaining data from the source time-series domains, and applying instance normalization and segmenting the time-series data into subseries-level normalized patches for the target time-series domain. The normalized patches are fed into a transformer encoder to generate high-dimensional representations of the normalized patches, and a limited number of samples from the target time-series domain are utilized to learn the prompt specific to the target domain. A cosine similarity between the prompt of the target domain and the prompts of all source domains is calculated to identify a nearest neighbor prompt, and the nearest neighbor prompt is utilized for model prediction in the target time-series domain.

According to another aspect of the present invention, a computer program product is provided for adapting a model trained from multiple source time-series domains to a target time-series domain, including instructions for integrating input data from a plurality of source time-series domains to pretrain a model, the model including a set of domain-invariant representations, fine-tuning the pretrained model by learning prompts specific to each source time-series domain using remaining data from the source time-series domains, and applying instance normalization and segmenting the time-series data into subseries-level normalized patches for the target time-series domain. The normalized patches are fed into a transformer encoder to generate high-dimensional representations of the normalized patches, and a limited number of samples from the target time-series domain are utilized to learn the prompt specific to the target domain. A cosine similarity between the prompt of the target domain and the prompts of all source domains is calculated to identify a nearest neighbor prompt, and the nearest neighbor prompt is utilized for model prediction in the target time-series domain.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a method for time-series model adaptation and prediction for a model trained from multiple source time-series domains to a target time-series domain, in accordance with embodiments of the present invention;

FIG. 3 is a diagram illustratively depicting a method for adapting a model trained from multiple source time-series domains to a target time-series domain by integrating, normalizing, and processing time-series data to generate high-dimensional representations for model adaptation, in accordance with embodiments of the present invention;

FIG. 4 is a diagram illustratively depicting a system and method for time-series model adaptation using a Prompt-Based Modular Network (PBMN-1) architecture including an encoder, a decoder, and dynamic routing components, in accordance with embodiments of the present invention;

FIG. 5 is a diagram illustratively depicting a system and method for time-series model adaptation using a Prompt-Based Modular Network (PBMN-2) architecture including a Patch Time Series Transformer (PatchTST) and modular network components, in accordance with embodiments of the present invention;

FIG. 6 is a diagram illustratively depicting a system and method for adapting models to various time-series domains for diverse applications and environments to provide accurate predictions, monitor trends, and optimize system operations, in accordance with embodiments of the present invention;

FIG. 7 is a diagram illustratively depicting a high-level view of a method for model pretraining, prompt tuning, and prediction using Prompt-Based Modular Network (PBMN) models, in accordance with embodiments of the present invention; and

FIG. 8 is a diagram illustratively depicting an exemplary processing system for adapting a model trained from multiple source time-series domains to a target time-series domain by integrating, normalizing, and processing time-series data to generate high-dimensional representations for model adaptation, in accordance with embodiments of the present invention.

### DETAILED DESCRIPTION

The present invention pertains to the field of time-series data analysis and model adaptation, including a system and method for adapting neural network models trained on multiple source time-series domains to a target time-series domain by integrating domain-specific prompts, utilizing transformer encoders, and dynamically routing connections between sub-networks to achieve accurate predictions and improved model generalization across diverse applications.

In accordance with various embodiments, systems and methods are provided for adapting neural network models to diverse time-series data domains. The invention can efficiently and accurately adapt models trained on multiple source time-series domains to a target time-series domain by leveraging domain-specific prompts and a modular network architecture. The system and method can receive as input a variety of time-series data, preprocess it using techniques such as instance normalization and patching, and then transform it into high-dimensional representations using a Patch Time Series Transformer (PatchTST). In some embodiments, the present invention can integrate a sophisticated modular neural network composed of dynamically routed sub-encoders and sub-decoders managed by policy networks and routers. This architecture enables the model to automatically learn and adapt to domain-specific characteristics with minimal data from the target domain, ensuring accurate predictions and robust performance across varied time-series applications. The system's capability extends beyond traditional methods by not only capturing intricate temporal dependencies within the data but also bridging distribution gaps between different time-series domains.

Through this advanced framework, users can apply the system to various real-world applications, such as financial market analysis, healthcare monitoring, industrial equipment maintenance, and climate forecasting. The system can include a plurality of components, including modules and program instructions for data normalization, patching, embedding, and encoding, which collectively enhance the model's ability to generalize and perform well in unseen domains. A feedback loop mechanism within the system can be utilized for continuous fine-tuning and adaptation, ensuring that the model evolves and maintains comparatively high accuracy over time. The robust computational network supporting these tasks ensures the efficiency and scalability of the system, making it a powerful tool for time-series data analysis and model adaptation, applicable to a plurality of industries and applications, in accordance with aspects of the present invention.

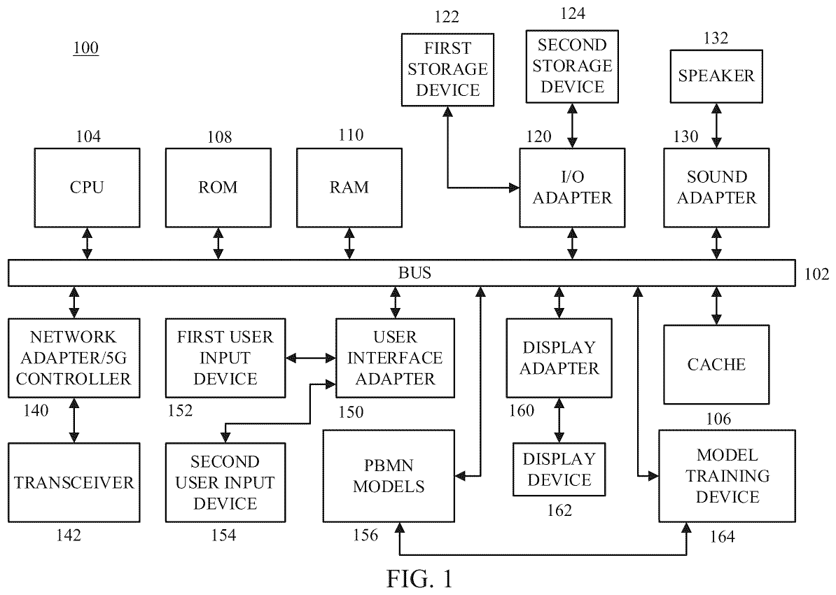

Referring now to the drawings in which like numerals represent the same or similar elements and initially to FIG. 1, an exemplary processing system 100, to which the present principles may be applied, is illustratively depicted in accordance with embodiments of the present invention.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. One or more Prompt-Based Modular Network (PBMN) models 156 can be utilized in conjunction with a model training device 164 for training and processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. The PBMN models 156 can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The PBMN models 156 can process received input, and a model training device 164 can be operatively connected to the system 100 for model training (e.g., using a neural network), in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

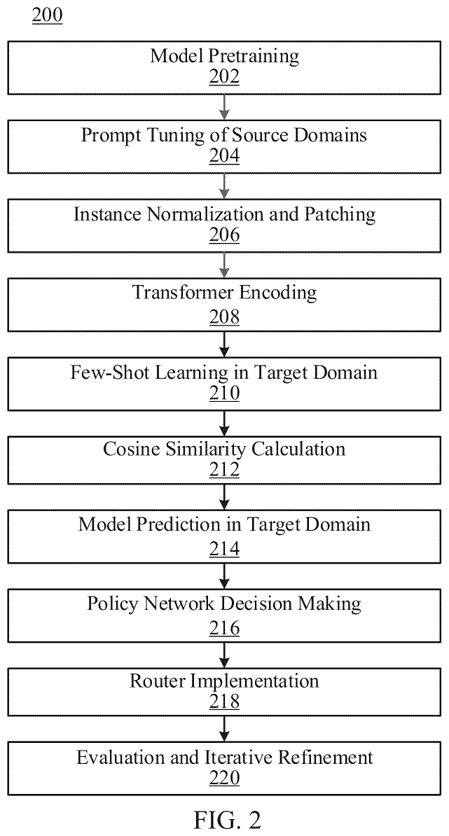

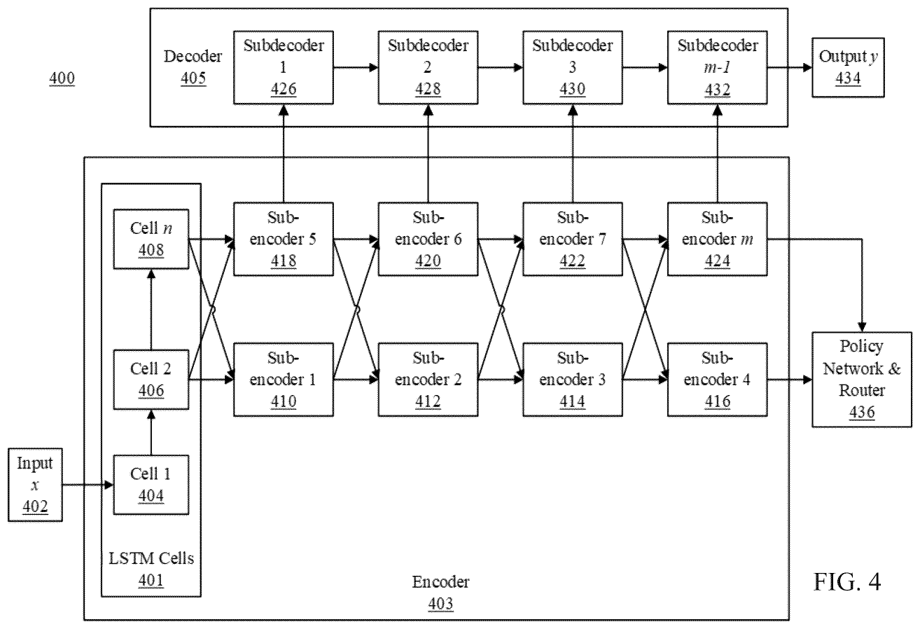

Moreover, it is to be appreciated that systems 400, 500, 600, and 800, described below with respect to FIGS. 4, 5, 6, and 8, respectively, are systems for implementing respective embodiments of the present invention. Part or all of processing system 100 may be implemented in one or more of the elements of systems 400, 500, 600, and 800, in accordance with aspects of the present invention. Further, it is to be appreciated that processing system 100 may perform at least part of the methods described herein including, for example, at least part of methods 200, 300, 400, 500, 600, and 700, described below with respect to FIGS. 2, 3, 4, 5, 6, and 7, respectively. Similarly, part or all of systems 400, 500, 600, and 800 may be used to perform at least part of methods 200, 300, 400, 500, 600, and 700 of FIGS. 2, 3, 4, 5, 6, and 7, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a method 200 for time-series model adaptation and prediction for a model trained from multiple source time-series domains to a target time-series domain, is illustratively depicted in accordance with embodiments of the present invention.

In various embodiments, in block 202, model pretraining can be initiated by integrating a substantial portion of data from multiple source time-series domains. This step can include the aggregation of diverse time-series datasets that exhibit various temporal dependencies and patterns. The PBMN-1 or PBMN-2 model can be employed to learn domain-invariant representations. During this phase, recurrent neural networks (RNNs), Long Short-Term Memory (LSTM) cells, Gated Recurrent Units (GRUs), and Multi-Layer Perceptrons (MLPs) can be utilized for feature extraction and pattern recognition. The training can be conducted using techniques such as backpropagation and gradient descent to optimize the model parameters. The aim is to establish a robust base model that captures the general patterns and dependencies across various time-series domains, which can serve as a foundation for subsequent steps.

In block 204, prompt tuning can be performed independently for each source time-series domain. This process can involve fine-tuning the pretrained model using the remaining data from each source domain. The prompts, which can act as meta-data, can help the model to understand the unique characteristics and distribution of each domain. For the Prompt-Based Modular Network (PBMN)-1 model, the prompts can be concatenated with the input time-series data, enhancing the model's ability to capture domain-specific features. For the PBMN-2 model, the prompts can be concatenated with the hidden embeddings derived from the time-series patches, enabling the model to adapt to the unique temporal patterns of each domain.

In block 206, for the PBMN-2 model, instance normalization and patching can be applied to each input time-series data. This involves segmenting the time-series data into subseries-level patches, which can then be normalized to ensure a consistent scale across all input data. Instance normalization can remove variations in the data, making it more homogeneous and improving model performance. The patches, which capture comprehensive semantic information by aggregating time steps into subseries-level units, can serve as input tokens for the Transformer encoder. This process can enable the model to capture both short-term and long-term dependencies within the time-series data. In block 208, the normalized patches can be fed into the Transformer encoder, which processes each patch independently. The Transformer encoder can leverage self-attention mechanisms to capture intricate dependencies within the time-series data. This can involve calculating attention scores that represent the importance of each time step within a patch. The output from the Transformer encoder can be a high-dimensional representation of the input data, which can be further processed by linear heads to generate the final time-series representation. The linear heads can map the high-dimensional representations to the desired output space, facilitating accurate predictions and inferences.

In block 210, few-shot learning can be conducted in the target time-series domain. This step involves utilizing a limited number of samples from the target domain to learn the prompt specific to this domain. The learned prompt can encapsulate the unique characteristics and distribution of the target domain, enabling the model to adapt quickly and efficiently. The few-shot learning process can involve techniques such as meta-learning and transfer learning, where the model can leverage knowledge from source domains to enhance its performance in the target domain. In block 212, cosine similarity can be calculated between the prompt of the target domain and the prompts of all source domains. This involves measuring the similarity between the target prompt and each source prompt using cosine similarity as the metric. The cosine similarity calculation can provide a measure of the angle between the vectors representing the prompts, indicating how similar they are. The source prompt with the highest similarity score can be identified as the nearest neighbor, which can serve as a guide for model prediction in the target domain.

In block 214, the nearest neighbor prompt from the source domains can be used for model prediction in the target domain. The selected prompt can guide the model to leverage the knowledge from the most similar source domain, improving the prediction accuracy and performance in the target domain. This step ensures that the model can effectively transfer its learning from source domains to the target domain, addressing distribution gaps and enhancing adaptability. The prediction process can involve generating forecasts, anomaly detection, or other time-series analysis tasks, depending on the application requirements. In block 216, the policy network can make decisions regarding the connections between sub-networks in the model. The policy network can estimate decision vectors that determine which sub-networks should be connected at each layer. This decision-making process can be based on the outputs of the previous layers and the current state of the model. The policy network can utilize reinforcement learning techniques to optimize the decision policies, ensuring that the model can dynamically adapt to varying time-series domains and data distributions.

In block 218, a straight-through router can be implemented to enforce the decision policies determined by the policy network. The router can estimate binary decision values indicating whether to connect or disconnect routes between sub-networks at each time step. This can involve applying thresholding techniques to the decision vectors generated by the policy network. The router can ensure that the optimal network configuration is maintained, enabling efficient information flow and processing within the model. In block 220, the model can be evaluated and iteratively refined based on its performance in the target domain. This step can involve using evaluation metrics such as mean squared error, accuracy, and F1 score to assess the model's performance. Based on the evaluation results, the model can be fine-tuned and optimized to improve its accuracy and generalization capabilities. Iterative refinement can involve adjusting hyperparameters, retraining specific components, and incorporating additional data to enhance the model's robustness and adaptability, in accordance with aspects of the present invention.

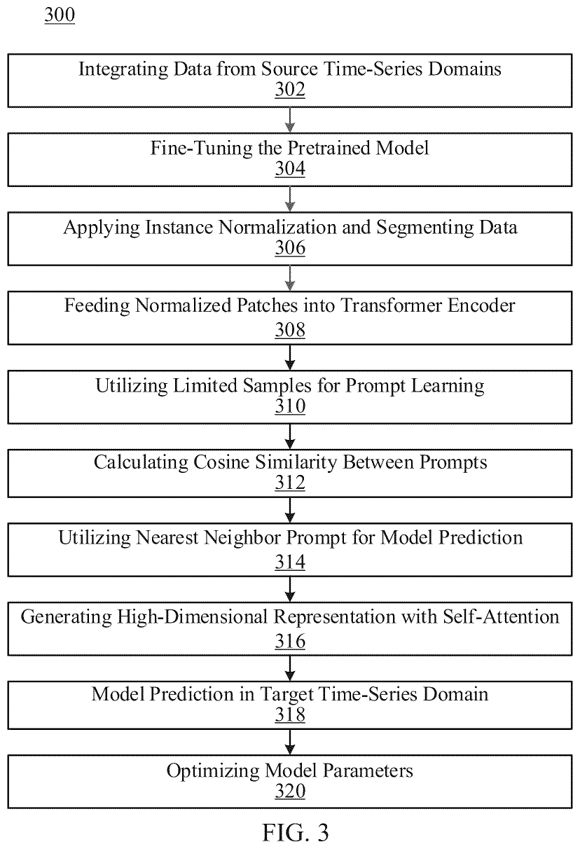

Referring now to FIG. 3, a method 300 for adapting a model trained from multiple source time-series domains to a target time-series domain by integrating, normalizing, and processing time-series data to generate high-dimensional representations for model adaptation, is illustratively depicted in accordance with embodiments of the present invention. In this context, “high-dimensional representations” refer to data transformations that encode input time-series data into a format with multiple features or dimensions, capturing intricate patterns and dependencies within the data. These representations can go beyond the original input dimensions to include various derived attributes, ensuring that all relevant information is preserved and highlighted for model adaptation. A purpose of these transformations is to facilitate more accurate and robust predictions by providing the model with a comprehensive and detailed view of the data's underlying structure.

In various embodiments, in block 302, data from a plurality of source time-series domains can be integrated to pretrain a model. This step can involve collecting extensive datasets from various domains, each exhibiting unique temporal dependencies and patterns. The integration process can include normalizing and standardizing the data to ensure consistency across different sources. This integrated dataset can then be used to train the model to capture domain-invariant representations, which can be robust and generalizable across various time-series domains. Techniques such as backpropagation and gradient descent can be utilized to optimize the model parameters during this pretraining phase.

In block 304, the pretrained model can be fine-tuned by learning prompts specific to each source time-series domain using the remaining data from these domains. Fine-tuning can involve adjusting the model parameters to better capture the unique characteristics and distributions of each source domain. For the PBMN-1 model, this process can include concatenating the prompts with the input time-series data. For the PBMN-2 model, the prompts can be concatenated with the hidden embeddings derived from time-series patches. This step can enhance the model's ability to adapt to domain-specific features, improving its overall performance and accuracy. In block 306, instance normalization and segmenting the time-series data into subseries-level patches can be applied for the target time-series domain. This step can involve normalizing the input data to remove variations and ensure consistency. The data can then be segmented into patches, which capture comprehensive semantic information by aggregating time steps into subseries-level units. This segmentation process can help the model to capture both short-term and long-term dependencies within the time-series data, providing a more detailed and structured representation of the input data.

In block 308, the normalized patches can be fed into a Transformer encoder to generate high-dimensional representations of the input data. The Transformer encoder can utilize self-attention mechanisms to capture intricate dependencies within the time-series data. This can involve calculating attention scores that represent the importance of each time step within a patch. The output from the Transformer encoder can be a high-dimensional representation of the input data, which can be further processed by linear heads to generate the final time-series representation. This step can enable the model to effectively capture complex patterns and relationships within the data.

In block 310, a limited number of samples from the target time-series domain can be utilized to learn the prompt specific to the target domain. This process can involve leveraging techniques such as meta-learning and transfer learning to adapt the model to the unique characteristics of the target domain. By using only a few samples, the model can quickly and efficiently learn the domain-specific prompt, which encapsulates the unique temporal patterns and dependencies of the target domain. This prompt can then be used to guide the model's predictions, improving its performance in the target domain. In block 312, cosine similarity can be calculated between the prompt of the target domain and the prompts of all source domains. This involves measuring the similarity between the target prompt and each source prompt using cosine similarity as the metric. The cosine similarity calculation can provide a measure of the angle between the vectors representing the prompts, indicating how similar they are. The source prompt with the highest similarity score can be identified as the nearest neighbor, which can serve as a guide for model prediction in the target domain. This step can ensure that the most relevant and similar source prompt is used for prediction, enhancing the model's accuracy.

In block 314, the nearest neighbor prompt from the source domains can be used for model prediction in the target time-series domain. The selected prompt can guide the model to leverage the knowledge from the most similar source domain, improving the prediction accuracy and performance in the target domain. This step can involve generating forecasts, anomaly detection, or other time-series analysis tasks based on the input data. By using the nearest neighbor prompt, the model can effectively transfer its learning from source domains to the target domain, addressing distribution gaps and enhancing adaptability. In block 316, a high-dimensional representation of the input data can be generated by applying self-attention mechanisms within the Transformer encoder. Self-attention mechanisms can capture complex dependencies within the time-series data by calculating attention scores for each time step. These scores can represent the importance of each time step relative to others, allowing the model to focus on the most relevant information. The high-dimensional representation generated by the Transformer encoder can then be used to enhance the model's predictions and analysis. This step can provide a more detailed and accurate representation of the input data, improving the overall performance of the model.

In block 318, the model prediction in the target time-series domain can comprise generating forecasts or anomaly detection based on the input data. This step can involve using the high-dimensional representations generated by the Transformer encoder and the nearest neighbor prompt to make accurate predictions. The model can be applied to various real-world scenarios, such as predicting future trends, detecting anomalies, or performing other time-series analysis tasks. This practical application of the model can demonstrate its effectiveness and versatility in different domains. In block 320, the model parameters can be optimized by utilizing techniques such as backpropagation and gradient descent. This step can involve adjusting the model's weights and biases to minimize the loss function and improve its accuracy. The optimization process can be performed iteratively, using training data to refine the model's parameters and enhance its performance. By optimizing the model parameters, the model can achieve better generalization and adaptability across different time-series domains, ensuring its robustness and reliability in various applications, in accordance with aspects of the present invention.

Referring now to FIG. 4, a system and method 400 for time-series model adaptation using a Prompt-Based Modular Network (PBMN-1) architecture including an encoder, a decoder, and dynamic routing components, is illustratively depicted in accordance with embodiments of the present invention. In various embodiments, the system and method can utilize various components such as an encoder, a decoder, and a policy network and router, which can work together to process input time-series data, generate high-dimensional representations, and produce the desired output. The architecture can capture intricate temporal dependencies and patterns in the time-series data from multiple source domains and adapt them for target domain predictions.

In various embodiments, in block 402, time-series data, denoted as x, can be received as input. This data can be sourced from various domains, including but not limited to sensors, financial records, and medical devices. The input time-series data can serve as the initial raw data that the system will process through several stages to produce accurate predictions or analyses. In block 401, the input time-series data x can be processed by a series of independent Long Short-Term Memory (LSTM) cells. These LSTM cells are designed to capture and retain the temporal dependencies and patterns within the input data. LSTM cells are a type of recurrent neural network (RNN) that are well-suited for handling sequences of data, making them ideal for time-series analysis. Each LSTM cell can operate independently to learn different aspects of the temporal sequences. In block 404, Cell 1 is the first independent LSTM cell in the series. It can be utilized to begin the process of capturing the initial temporal dependencies in the input data. The processed output from Cell 1 can be passed to the subsequent cells for further temporal analysis. In block 406, Cell 2, another independent LSTM cell, can continue processing the input data from Cell 1. Each subsequent LSTM cell, including Cell 2, can capture additional patterns and dependencies in the data, refining the information further. The output from Cell 2 can be then passed on to the next cell. In block 408, Cell n can represent the final independent LSTM cell in the series. This cell can capture the long-term dependencies in the input time-series data, ensuring that the model retains relevant information across the entire sequence. The processed output from Cell n can be then used as the input for the next stage of the system, the encoder. The encoder can be utilized to discover a set of generalizable sub-networks that are composed in different combinations of time-series domains. An exemplary encoder has m layers and the l-th layer consists of nₗ subnetworks. The first layer can refer to a group of independent LSTM cells. Other layers can include a plurality of Multi-Layer Perceptrons (MLPs) that can be used as subencoders

In block 403, the encoder can process the output from the LSTM cells. The encoder is designed to discover a set of generalizable sub-networks that are composed in different combinations for various time-series domains. It consists of multiple layers, each containing several sub-encoders. These sub-encoders can transform the data into higher-level representations, capturing more abstract features and patterns in the time-series data. In block 410, Sub-encoder 1 can be part of the first layer of the encoder network. Sub-encoder 1 can process the output from the LSTM cells, transforming the data into a higher-level representation. This transformation allows the model to capture more abstract features and patterns within the time-series data, facilitating better understanding and predictions. In block 412, Sub-encoder 2 can continue the data processing started by Sub-encoder 1. Each sub-encoder in this layer can learn different aspects of the time-series data, contributing to a more comprehensive understanding of the input. The sub-encoders in this layer can work together to refine the representations generated by the previous layers. In block 414, Sub-encoder 3 can process the data further, continuing the refinement of the high-level representations generated by the previous sub-encoders. The interconnected sub-encoders can share information and improve the overall data representation, capturing complex dependencies and interactions within the time-series data. In block 416, Sub-encoder 4 can contribute to the data processing by enhancing the higher-level representations generated by the previous sub-encoders. This continuous refinement process ensures that intricate patterns within the time-series data are captured, improving the model's predictive capabilities. Sub-encoders 5, 6, and 7, represented by numerals 418, 420, and 422, respectively, perform similar functions to the previously described sub-encoders (e.g., Sub-encoder 4 in block 416). In block 424, Sub-encoder m can represent the final sub-encoder in the layer. This sub-encoder ensures that the final representation of the time-series data captures all necessary patterns and dependencies. The processed output from Sub-encoder m can be then passed to the decoder for further analysis and prediction.

In block 405, a decoder can process the high-level representations from the encoder. The decoder can selectively activates parts of the encoder through multiple sub-decoders to extract domain-related knowledge. The decoder can be composed of m−1 independent sub-decoders, each designed to refine and transform the encoded data into the final output. The decoder shares a similar idea with the encoder, and can selectively activate only parts of the encoder in various embodiments. An exemplary decoder can have m−1 independent sub-decoders, which can be used to extract domain-related knowledge from different layers of the encoder. For illustrative purposes, we use MLPs as the subdecoders, but it is noted that any sort of subencoders or subdecoders can be utilized in accordance with aspects of the present invention.

In block 426, Subdecoder 1 can process the output from the encoder's sub-encoders. Subdecoder 1 can begin the transformation of the high-level representations into the final output format. This subdecoder ensures that relevant domain-specific information is extracted from the encoded data. In block 428, Subdecoder 2 can continue the transformation process initiated by Subdecoder 1. Each subdecoder in the decoder network can extract and refine different aspects of the high-level representations, ensuring a comprehensive transformation of the data. The processed output from Subdecoder 2 can be then passed to the next subdecoder. In block 430, Subdecoder 3 can process the output from Subdecoder 2. The subdecoders can work in sequence (or in a predefined order) to ensure that the final output is accurate and reflective of the input time-series data's intricate patterns. The processed output from Subdecoder 3 can be passed to the final subdecoder for further refinement. In block 432, Subdecoder m−1 can represent the final subdecoder in the decoder network. This subdecoder ensures that the final output captures all necessary patterns and dependencies from the input time-series data for accurate and efficient processing. The processed output from Subdecoder m−1 can be then passed to the final output block.

In block 434, the final output y can be generated. This output can represent the predictions or analyses based on the input time-series data. The output y can be used for various applications, such as financial forecasting, healthcare monitoring, or industrial maintenance, depending on the initial input data and the domain-specific prompts used during the fine-tuning process. In block 436, a policy network and router can manage the connections between sub-encoders and sub-decoders. The policy network can estimate decision vectors for each sub-encoder, determining the connections to the sub-networks of the previous layer. In various embodiments, the policy network for each sub-encoder can make decision connections between itself and the sub-networks of the previous layer. For example, for sub-encoder j in the l-th layer, policy network Nⱼ can estimate a decision vector α_{t,ij} ∈R² for every subnetwork i in the (l−1)-th layer at the time step t, given the output u_{t,i} of sub-network i at the time step t as follows:

$${N}_{j} : {u}_{t , i} \to {α}_{t , ij} \cdot i ∈ \{ 1 , ⋯ , {n}_{l - 1} \} , j ∈ \{ 1 , ⋯ , {n}_{l} \} .$$

In various embodiments, the router can learn the decision policy and estimates binary decision values to connect or disconnect routes between sub-networks. For example, given α_{t,ij}, a straight-through router is used to learn the decision policy Pᵢⱼ, which estimates a binary decision value β_{t,ij} ∈{0, 1}, indicating whether to connect (β_{t,ij}=1) or disconnect (β_{t,ij}=0) the route between the subnetwork i and the sub-encoder j at time step t is as follows:

$${P}_{i j} : {α}_{t , ij} \to {β}_{t , ij} \cdot i ∈ \{ 1 , ⋯ , {n}_{l - 1} \} , j ∈ \{ 1 , ⋯ , {n}_{l} \} .$$

The PBMN-1 model is denoted as f₁, xᵢ, Pᵢ and yᵢ are the input, the prompt and the output of the i-th source time-series domain. In the model pretraining phase, f₁ can be pretrained by (xᵢ, yᵢ) as follows: yᵢ=f₁ (xᵢ; θ₁) where θ₁ is the set of parameters of the f₁. In the prompt tuning phase, θ₁ can be fixed, and pᵢ can be tuned as follows: yᵢ=f₁ ([xᵢ, Pᵢ]; θ₁), where [xᵢ, Pᵢ] is the concatenation of xᵢ and pᵢ. This dynamic routing ensures that the model adapts to the specific characteristics of different time-series domains, enhancing its predictive accuracy and generalizability, in accordance with aspects of the present invention.

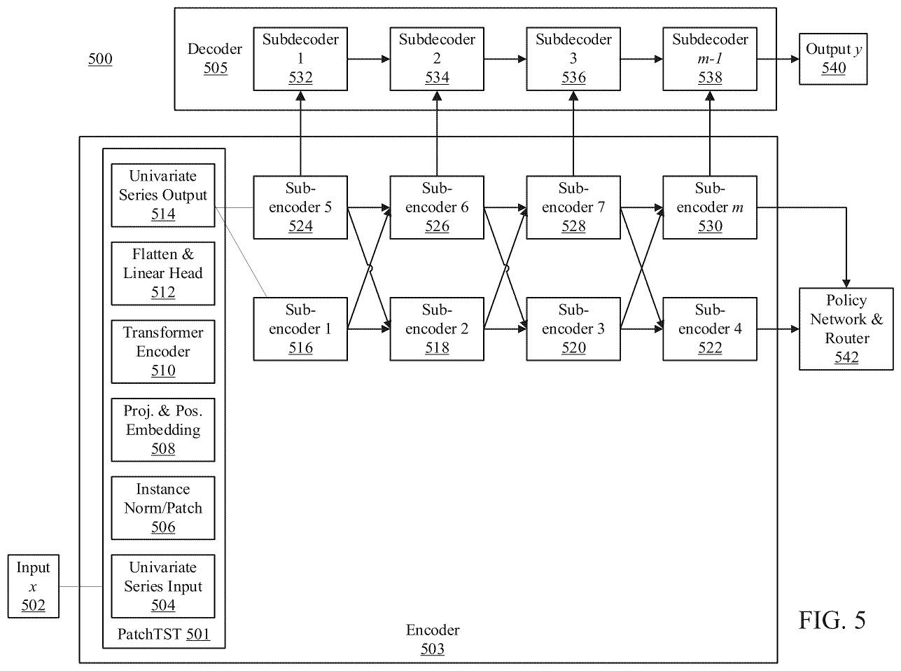

Referring now to FIG. 5, a system and method 500 for time-series model adaptation using a Prompt-Based Modular Network (PBMN-2) architecture including a Patch Time Series Transformer (PatchTST) and modular network components, is illustratively depicted in accordance with embodiments of the present invention. In various embodiments, the system and method 500 can utilize various components such as PatchTST for initial processing, an encoder for transforming data into high-dimensional representations, a decoder for refining these representations, and a policy network and router for dynamic routing and decision-making. The system can process input time-series data, generate high-dimensional embeddings, and produce accurate predictions or analyses. The architecture is designed to handle diverse time-series data and adapt to different domains by learning domain-specific prompts, which can guide the model's predictions.

In various embodiments, in block 502, time-series data, denoted as x, can be received as input. This data can be sourced from various domains, including but not limited to sensors, financial records, and medical devices. The input time-series data can serve as the initial raw data that the system will process through several stages to produce accurate predictions or analyses. The data can be formatted as univariate series, where each channel represents a distinct feature of the time-series data. In block 501, a Patch Time Series Transformer (PatchTST) can begin the initial processing of the input time-series data. PatchTST can capture comprehensive semantic information by aggregating time steps into subseries-level patches, ensuring that the model handles the data efficiently and effectively. The PatchTST layer can help in segmenting the input time-series into manageable and meaningful chunks for further processing. This step is essential for transforming raw time-series data into a structured format suitable for the Transformer encoder.

In block 504, the univariate series input can be processed. This involves handling each time-series data channel independently to preserve the distinct information contained in each channel. The univariate series input ensures that the initial data segmentation aligns with the inherent structure of the time-series data. Each univariate series represents a single variable observed over time, which can be critical for applications where individual channel information is necessary for accurate predictions. In block 506, instance normalization and patching can be applied to the input data. Instance normalization can standardize the data to remove variations and ensure consistency across different time-series instances. This normalization step can mitigate the effects of varying scales and distributions in the input data, enhancing the model's stability and performance. Patching can segment the data into smaller, more manageable patches that serve as input tokens for the Transformer encoder. This segmentation process can help in capturing local temporal patterns within each patch, improving the model's ability to learn from complex time-series data.

In block 508, the system can apply projection and position embedding to the normalized and patched data. Projection can transform the data into a suitable format for the Transformer encoder by adjusting the dimensionality and scaling of the input tokens. Position embedding can incorporate the temporal order of the data, allowing the model to understand the sequential nature of the time-series data. This embedding process can provide the Transformer encoder with the necessary context to capture the temporal dependencies within the time-series data accurately. In block 510, the patched and embedded data can be processed by the Transformer encoder. The Transformer encoder can utilize self-attention mechanisms to capture intricate dependencies within the time-series data, generating high-dimensional representations that encapsulate the essential patterns and relationships in the data. Self-attention mechanisms can calculate the importance of each time step relative to others, allowing the model to focus on the most relevant parts of the time-series data. This step is pivotal for enhancing the model's ability to learn from complex temporal sequences and produce accurate predictions.

In block 512, the high-dimensional representations from the Transformer encoder can be flattened and processed by a linear head. Flattening can convert the multi-dimensional data into a single vector, simplifying the structure for subsequent processing. The linear head can apply a linear transformation to generate a final high-dimensional representation, which can be used for output generation or further processing by the decoder. This step can ensure that the model's output is in a format suitable for analysis and prediction. In block 514, the system can generate the univariate series output, which represents the processed time-series data in a format suitable for analysis or prediction. This output can be used directly or passed on to the decoder for further refinement. The univariate series output ensures that the processed data retains its temporal structure and is ready for subsequent stages. This output can be critical for applications requiring detailed analysis of individual time-series channels.

In block 503, the encoder can process the high-dimensional representations from the PatchTST. The encoder can discover a set of generalizable sub-networks composed in different combinations for various time-series domains. It can consist of multiple layers, each containing several sub-encoders. These sub-encoders can transform the data into even higher-level representations, capturing more abstract features and patterns in the time-series data. The encoder's ability to generate domain-invariant representations is essential for adapting the model to different time-series domains. In block 516, Sub-encoder 1 is part of the first layer of the encoder network. Sub-encoder 1 can process the output from the PatchTST, transforming the data into a higher-level representation. This transformation allows the model to capture more abstract features and patterns within the time-series data, facilitating better understanding and predictions. Each sub-encoder can focus on different aspects of the data, contributing to a comprehensive representation of the input time-series. In block 518, Sub-encoder 2 can continue the data processing started by Sub-encoder 1. Each sub-encoder in this layer can learn different aspects of the time-series data, contributing to a more comprehensive understanding of the input. The sub-encoders in this layer can work together to refine the representations generated by the previous layers. This collaborative processing can enhance the model's ability to capture complex temporal patterns and relationships.

In block 520, Sub-encoder 3 can process the data further, continuing the refinement of the high-level representations generated by the previous sub-encoders. The interconnected sub-encoders can share information and improve the overall data representation, capturing complex dependencies and interactions within the time-series data. This continuous refinement process can ensure that the model captures all relevant features necessary for accurate predictions. In block 522, Sub-encoder 4 can contribute to the data processing by enhancing the higher-level representations generated by the previous sub-encoders. This continuous refinement process ensures that intricate patterns within the time-series data are captured, improving the model's predictive capabilities. The ability to capture detailed temporal relationships can be crucial for applications requiring precise time-series analysis. Sub-encoders 5, 6, and 7, represented by numerals 524, 526, and 528, respectively, perform similar functions to the previously described sub-encoders (e.g., Sub-encoder 4 in block 522). In block 530, Sub-encoder m is the final sub-encoder in the layer. This sub-encoder ensures that the final representation of the time-series data captures all necessary patterns and dependencies. The processed output from Sub-encoder m is then passed to the decoder for further analysis and prediction. This final stage of the encoder ensures that the data is fully transformed and ready for the next stage of processing.

In block 505, a decoder can process the high-level representations from the encoder. The decoder selectively activates parts of the encoder through multiple sub-decoders to extract domain-related knowledge. The decoder can be composed of m−1 independent sub-decoders, each designed to refine and transform the encoded data into the final output. This selective activation ensures that the most relevant features are utilized for predictions. In block 532, Subdecoder 1 can process the output from the encoder's sub-encoders. Subdecoder 1 can begin the transformation of the high-level representations into the final output format. This subdecoder ensures that relevant domain-specific information is extracted from the encoded data. The ability to selectively activate different parts of the encoder can enhance the model's flexibility and accuracy. In block 534, Subdecoder 2 can continue the transformation process initiated by Subdecoder 1. Each subdecoder in the decoder network extracts and refines different aspects of the high-level representations, ensuring a comprehensive transformation of the data. The processed output from Subdecoder 2 is passed to the next subdecoder. This sequential processing can ensure that the final output captures all necessary patterns and relationships. In block 536, Subdecoder 3 can process the output from Subdecoder 2. The subdecoders work in sequence to ensure that the final output is accurate and reflective of the input time-series data's intricate patterns. The processed output from Subdecoder 3 is passed to the final subdecoder for further refinement. This stage can ensure that all relevant features are captured and utilized for predictions. In block 538, Subdecoder m−1 is the final subdecoder in the decoder network. This subdecoder ensures that the final output captures all necessary patterns and dependencies from the input time-series data. The processed output from Subdecoder m−1 is then passed to the final output block. This final transformation stage can ensure that the output is in the correct format and fully leverages the learned features.

For the PBMN-2 model, we use the Patch Time Series Transformer (PatchTST) due to its two key designs: patching and channel-independence. Patching means that we capture comprehensive semantic information by aggregating time steps into subseries-level patches. Channel-independence is referred to that each input token only contains information from a single channel. Specifically, as is shown in FIG. 2, each channel univariate series is passed through instance normalization operator and segmented into patches. These patches are used as Transformer input tokens. Then the representation of the time-series is outputted by passing the Transformer encoder and linear heads. In this illustrative example, we denote PatchTST as g, the instance normalization, patching and the position embedding are denoted as g₁, and the Transformer encoder and linear heads are denoted as g₂. Then zᵢ=g (xᵢ, η)=g₂ (g₁ (xᵢ)), where zᵢ is the output of the i-th source time-series domain from the PatchTST, and η is the set of parameters of the PatchTST.

The PBMN-2 model excluding the PatchTST can be denoted as f₂. In this exemplary model pretraining phase, f₂ can be pretrained by (xᵢ, yᵢ) as follows: yᵢ=f₂ (g (xᵢ, η); θ₂) where θ₂ is the set of parameters of the f₂. In the prompt tuning phase, θ₂ can be fixed, and pi can be tuned as follows: yᵢ=f₂ (G₂ ([g₁ (xᵢ), pᵢ]); θ₂), where [g₁ (xᵢ), pᵢ] is the concatenation of g₁ (xᵢ) and pᵢ. In other words, the prompt of the i-th source domain pᵢ can be concatenated to the time-series patches g₁ (xᵢ), which can serve as the input of g₂. This is a difference between the PBMN-1 and the PBMN-2: the prompt of the PBMN-1 model is concatenated to the input xᵢ, while the prompt of the PBMN-2 model is concatenated to the time-series patches g₁ (xᵢ), which is the hidden embedding of xᵢ. For a few shot transfer step, the prompt in the target time-series domain can be denoted as p, we can select the nearest neighbor pᵢ by the cosine similarity between p and all prompts in the source time-series domain as follows:

$${p}_{i} = argmax \frac{{p}_{i} p}{\vert \vert {p}_{i} \vert \vert \vert \vert p \vert \vert} ,$$

and we can use pᵢ for model perdition in the target time-series domain.

In block 540, the final output y can be generated. This output can represent the predictions or analyses based on the input time-series data. The output y can be used for various applications, such as financial forecasting, healthcare monitoring, or industrial maintenance, depending on the initial input data and the domain-specific prompts used during the fine-tuning process. This output can provide actionable insights based on the processed time-series data. In block 542, the policy network and router can manage the connections between sub-encoders and sub-decoders. The policy network estimates decision vectors for each sub-encoder, determining the connections to the sub-networks of the previous layer. The router learns the decision policy and estimates binary decision values to connect or disconnect routes between sub-networks. This dynamic routing ensures that the model adapts to the specific characteristics of different time-series domains, enhancing its predictive accuracy and generalizability. The ability to dynamically adjust connections can improve the model's flexibility and performance across diverse applications, in accordance with aspects of the present invention.

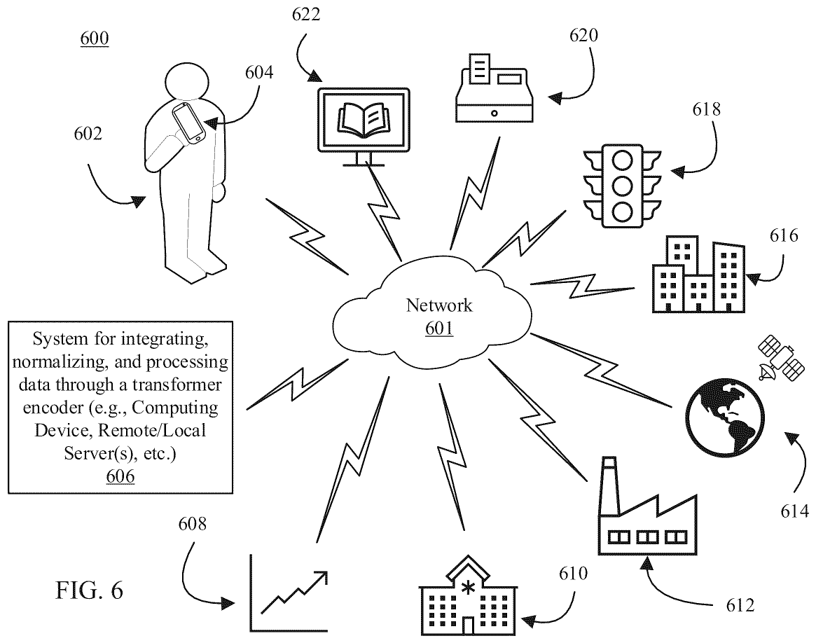

Referring now to FIG. 6, a system and method 600 for adapting models to various time-series domains for diverse applications and environments to provide accurate predictions, monitor trends, and optimize system operations, is illustratively depicted in accordance with embodiments of the present invention.

In various embodiments, a user 602, can interact with the system via a personal computing device 604 (e.g., smartphone, personal computer, tablet, etc.), which can be used to input time-series data, receive predictions, and manage various applications. The mobile device can connect to the system via a network 601, enabling real-time data exchange and interaction. The user interface on, for example, a mobile device can provide a platform for visualizing predictions, monitoring system performance, and customizing the model's parameters and settings. The user device 604 (e.g., smartphone, personal computer, tablet, etc.) can be utilized to interact with the inventive system. This device can serve as an interface for the user to input data, receive predictions, and interact with the system. The mobile user device can be equipped with various sensors and input mechanisms to collect time-series data, which can be transmitted to the server for processing. The device can also display the results of the model's predictions, providing real-time insights and analytics to the user.

In block 606, a computing device (e.g., server housing the inventive system) can be utilized, and can be a remote or local computing device that stores and executes the model. It can handle the integration, normalization, and processing of time-series data through a transformer encoder. The server can also manage the fine-tuning of the model with domain-specific prompts and perform the necessary calculations for cosine similarity and model prediction. The server can be connected to the user device via a network 601, allowing for seamless data exchange and interaction. In block 628, a computing network is illustratively depicted, which can be local, remote, or internet-based, can connect the user device and the server to various sites and applications. This connection enables the transfer of time-series data from the user device to the server and the delivery of predictions and insights back to the user. The network can support real-time data exchange, ensuring that the system operates efficiently and effectively across different environments and applications.

In block 608, the present invention can be utilized for financial market analysis, where the model can be used to predict stock prices, identify trends, and detect anomalies in trading patterns. Financial time-series data, such as stock prices, trading volumes, and economic indicators, can be integrated from multiple sources to pretrain the model. The model can be fine-tuned to capture the unique characteristics of different financial markets. For instance, prompts specific to the New York Stock Exchange, NASDAQ, and international markets can be learned. The normalized patches of financial data can be fed into the Transformer encoder to generate high-dimensional representations, which can be used to predict future stock prices, identify potential investment opportunities, and detect unusual trading activities.

In block 610, the invention can be utilized in healthcare monitoring and diagnostics. Time-series data from various medical devices and patient records, such as ECG readings, blood pressure measurements, and glucose levels, can be integrated to pretrain the model. The model can be fine-tuned with prompts specific to different medical conditions and patient demographics. By normalizing and segmenting the medical data into patches, the Transformer encoder can generate high-dimensional representations that can be used to monitor patient health, predict potential health issues, and provide early warnings for medical conditions. This application can enhance patient care by enabling continuous monitoring and timely diagnostics. In block 606, the invention can be utilized for proactive industrial equipment maintenance, where it can predict equipment failures and schedule preventive maintenance. Time-series data from various sensors monitoring industrial machines, such as temperature, vibration, and pressure sensors, can be integrated to pretrain the model. Fine-tuning the model with prompts specific to different types of equipment and operational conditions can enhance its predictive capabilities. By feeding normalized sensor data into the Transformer encoder, the model can generate high-dimensional representations that can be used to identify patterns indicative of potential equipment failures, optimize maintenance schedules, and reduce downtime, leading to increased operational efficiency.

In block 614, the invention can be leveraged for climate and weather forecasting. Time-series data from meteorological stations, satellites, and climate models, including temperature, humidity, and precipitation measurements, can be integrated to pretrain the model. The model can be fine-tuned with prompts specific to different geographical regions and climate conditions. Normalizing and segmenting the weather data into patches allows the Transformer encoder to generate high-dimensional representations that can be used to predict weather patterns, forecast extreme weather events, and analyze long-term climate trends. This application can improve the accuracy of weather forecasts and support climate research and planning. In block 616, the invention can be applied to optimize energy consumption in smart grids and buildings. Time-series data from energy meters, smart appliances, and renewable energy sources, such as solar panels and wind turbines, can be integrated to pretrain the model. The model can be fine-tuned with prompts specific to different energy consumption patterns and sources. By normalizing and segmenting the energy data into patches, the Transformer encoder can generate high-dimensional representations that can be used to predict energy demand, optimize energy distribution, and enhance the efficiency of energy usage. This application can contribute to energy savings and support sustainable energy management.

In block 618, the invention can be utilized for traffic management and prediction. Time-series data from traffic sensors, GPS devices, and transportation networks, including vehicle counts, speeds, and travel times, can be integrated to pretrain the model. The model can be fine-tuned with prompts specific to different cities and traffic conditions. Normalizing and segmenting the traffic data into patches allows the Transformer encoder to generate high-dimensional representations that can be used to predict traffic congestion, optimize traffic flow, and improve transportation planning. This application can enhance urban mobility and reduce traffic-related issues. In block 620, the invention can be applied to retail sales forecasting, where it can predict future sales, manage inventory, and optimize supply chains. Time-series data from point-of-sale systems, online sales platforms, and market trends, including sales volumes, prices, and customer preferences, can be integrated to pretrain the model. Fine-tuning the model with prompts specific to different product categories and market segments can enhance its forecasting capabilities. By feeding normalized sales data into the Transformer encoder, the model can generate high-dimensional representations that can be used to forecast sales, manage stock levels, and improve supply chain efficiency.

In block 622, the invention can be applied to natural language processing (NLP) tasks, such as sentiment analysis, language translation, and text generation. Time-series data from text corpora, social media posts, and other linguistic sources can be integrated to pretrain the model. The model can be fine-tuned with prompts specific to different languages and contexts. Normalizing and segmenting the text data into patches allows the Transformer encoder to generate high-dimensional representations that can be used for various NLP applications, such as analyzing sentiments in social media, translating texts between languages, and generating coherent text sequences. This application can improve the accuracy and efficiency of NLP systems, in accordance with aspects of the present invention.

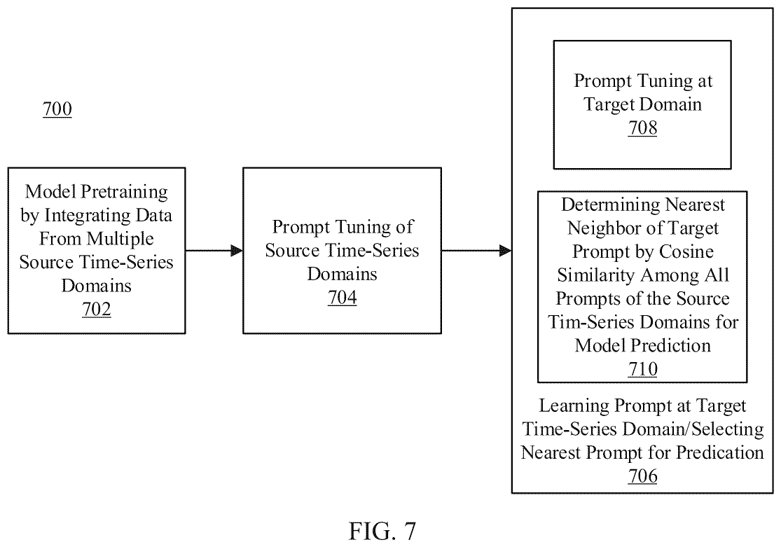

Referring now to FIG. 7, a high-level view of a method 700 for model pretraining, prompt tuning, and prediction using Prompt-Based Modular Network (PBMN) models, is illustratively depicted in accordance with embodiments of the present invention. The method 700 can include several stages: model pretraining, prompt tuning of source time-series domains, and prompt tuning and selection at the target domain. This method can be utilized to adapt models trained on multiple source time-series domains to a target time-series domain by leveraging domain-specific prompts and dynamic model adaptation techniques.

In various embodiments, in block 702, an initial stage can include model pretraining by integrating data from multiple source time-series domains. The PBMN model can be pretrained using a large portion of data from each source domain to learn domain-invariant representations of time-series data. This pretraining phase ensures that the model captures general patterns and dependencies that are common across different time-series domains, forming a robust foundation for further tuning. In block 704, a prompt tuning phase for each source time-series domain can be initiated. During this phase, the remaining data from each source domain can be used to learn the prompt specific to that domain. These prompts act as meta-data that control the time-series distribution, allowing the model to understand and differentiate between the unique characteristics of each source domain. This tuning process is particularly useful for enabling the model to generalize well across different domains.

In block 706, the workflow can move to the target time-series domain, where selected samples from the target domain can be used to learn the prompt specific to this new domain. This prompt tuning at the target domain ensures that the model adapts to the unique characteristics of the target domain with minimal data. Once the prompt for the target domain is learned, the model can select the nearest prompt from the source domains for prediction, facilitating accurate and efficient model adaptation. In block 708, the prompt tuning process at the target domain is detailed. This step involves using a limited number of samples from the target time-series domain to fine-tune the model and learn the target domain-specific prompt. This prompt captures the essential features and patterns of the target domain, allowing the model to adjust its predictions accordingly. The ability to tune prompts with minimal data ensures rapid adaptation to new domains. In block 710, the model can determine the nearest neighbor of the target prompt by calculating the cosine similarity between the target prompt and all prompts of the source time-series domains. This step involves identifying the source domain prompt that is most similar to the target domain prompt, which is then used for model prediction in the target domain. The use of cosine similarity for prompt selection ensures that the model leverages the most relevant knowledge from the source domains, enhancing prediction accuracy and performance in the target domain, in accordance with aspects of the present invention.

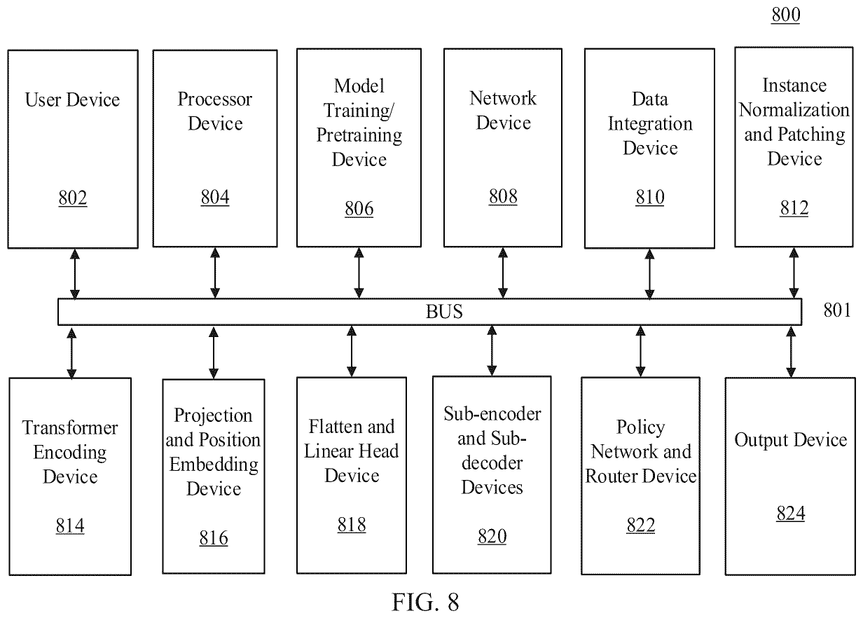

Referring now to FIG. 8, a high-level view of a system 800 for adapting a model trained from multiple source time-series domains to a target time-series domain by integrating, normalizing, and processing time-series data to generate comparatively high-dimensional representations for model adaptation, is illustratively depicted in accordance with embodiments of the present invention. FIG. 8 represents an overall system architecture for adapting a model trained from multiple source time-series domains to a target time-series domain is illustrated. This system can include various components such as user devices, servers, networks, and specialized processing modules. These components can work together to integrate, normalize, and process time-series data, ultimately generating high-dimensional representations for accurate model adaptation and prediction. The system is designed to handle diverse applications and environments, providing robust performance across different time-series domains.

In various embodiments, in block 801, a system bus is depicted, serving as the communication backbone for various components within the system. The bus can facilitate data transfer and communication between different devices and modules, ensuring seamless integration and coordination of the system's operations. It connects all the major components, allowing them to share information and work together efficiently. A user device 802 (e.g., smartphone, personal computer, tablet, etc.) can be utilized to interact with the system. This device can serve as the interface for the user to input time-series data, receive predictions, and manage various applications. The user device can be equipped with sensors and input mechanisms to collect data, which is then transmitted to the server for processing. It can also display the results of the model's predictions, providing real-time insights and analytics to the user. A processor device 804 can be employed to handle the computational tasks of the system. This processor can execute the necessary algorithms and operations required for integrating, normalizing, and processing time-series data. It can also manage the fine-tuning of the model with domain-specific prompts, performing the necessary calculations for cosine similarity and model prediction. The processor ensures that the system operates efficiently and effectively, handling complex data processing tasks with precision.

A model training/pretraining device 806 can be utilized to train and pretrain the neural network models. This device can handle the initial integration of data from multiple source time-series domains, using techniques such as backpropagation and gradient descent to optimize the model parameters. The training device ensures that the model captures general patterns and dependencies across different domains, forming a robust foundation for further tuning and adaptation. A network device 808 can be utilized to provide the connectivity between the user device and the server. This network can be local, remote, or internet-based, supporting real-time data exchange and interaction. The network device ensures that the time-series data is transmitted efficiently from the user device to the server, and that predictions and insights are delivered back to the user in a timely manner. It can support various communication protocols and technologies, ensuring reliable and secure data transfer. A data integration device 810 can be utilized to aggregate and standardize time-series data from multiple sources. This device can handle the preprocessing steps, such as normalizing and segmenting the data into patches, ensuring consistency across different data sources. The data integration module plays a crucial role in preparing the data for subsequent processing by the neural network models, ensuring that the input data is in a suitable format for analysis and prediction.

An instance normalization and patching device 812 can be employed to standardize and segment the input time-series data. This device can perform instance normalization to remove variations and ensure a consistent scale across all input data. It can also segment the data into subseries-level patches, capturing comprehensive semantic information and ensuring that the model handles the data efficiently and effectively. This module plays a role in enhancing the model's ability to learn from complex time-series data. A transformer encoder device 814 can be utilized to process the normalized and patched time-series data. This device can leverage self-attention mechanisms to capture intricate dependencies within the data, generating high-dimensional representations that encapsulate essential patterns and relationships. The transformer encoder ensures that the model effectively captures complex temporal sequences, enhancing its predictive capabilities.

A projection and position embedding device 816 can be employed to transform the normalized and patched data into a suitable format for the transformer encoder. This device can adjust the dimensionality and scaling of the input tokens, incorporating the temporal order of the data. The position embedding ensures that the model understands the sequential nature of the time-series data, providing the necessary context for accurate analysis and prediction. A flatten and linear head device 818 can be utilized to process the high-dimensional representations from the transformer encoder. This device can flatten the multi-dimensional data into a single vector and apply a linear transformation to generate the final high-dimensional representation. This representation can be used for output generation or further processing by the decoder, ensuring that the model's output is in a suitable format for analysis and prediction. Sub-encoder and sub-decoder devices 820 can represent the various modular components of the encoder and decoder networks. These sub-encoder and sub-decoder devices 820 can process the high-level representations from the transformer encoder, refining and transforming the data into the final output format. Each sub-encoder and sub-decoder can learn different aspects of the time-series data, contributing to a comprehensive and accurate representation of the input data.

A policy network and router device 822 can be employed to manage the connections between sub-encoders and sub-decoders. This device can estimate decision vectors for each sub-encoder, determining the optimal connections for efficient information flow and processing. The router can enforce these decision policies, ensuring that the model dynamically adapts to varying time-series domains and data distributions. This device enhances the model's flexibility and performance across diverse applications. An output device 824 can represent a final stage of the processes of the inventive system 800. This device can generate the predictions or analyses based on the processed time-series data, providing actionable insights for various applications. The output device 824 ensures that the results are delivered in a clear and concise format, ready for use by the user or other system components. This device is particularly useful for translating the model's learned patterns into practical and usable information for end users, in accordance with aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for adapting a model trained from multiple source time-series domains to a target time-series domain, comprising:
integrating input data from a plurality of source time-series domains to pretrain a model, the model including a set of domain-invariant representations;
fine-tuning the pretrained model by learning prompts specific to each source time-series domain using remaining data from the source time-series domains;
applying instance normalization and segmenting the time-series data into subseries-level normalized patches for the target time-series domain;
feeding the normalized patches into a transformer encoder to generate high-dimensional representations of the normalized patches;
utilizing a limited number of samples from the target time-series domain to learn the prompt specific to the target domain;
calculating cosine similarity between the prompt of the target domain and the prompts of all source domains to identify a nearest neighbor prompt; and
utilizing the nearest neighbor prompt for model prediction in the target time-series domain.

2. The method of claim 1, wherein the pretrained model comprises a PBMN-1 model, and the prompts are concatenated with input time-series data.

3. The method of claim 1, wherein the pretrained model comprises a PBMN-2 model, and the prompts are concatenated with hidden embeddings derived from time-series patches.

4. The method of claim 1, wherein the instance normalization and segmenting the time-series data into patches are performed by an instance normalization operator and a patching module, respectively.

5. The method of claim 1, further comprising generating a high-dimensional representation of the input data by applying self-attention mechanisms within the Transformer encoder.

6. The method of claim 1, wherein the model prediction in the target time-series domain comprises generating forecasts or anomaly detection based on the input data.

7. The method of claim 1, wherein the fine-tuning of the pretrained model involves utilizing backpropagation and gradient descent techniques to optimize parameters of the model.

8. A system for adapting a model trained from multiple source time-series domains to a target time-series domain, comprising: a processor device; and a memory storing instructions that, when executed by the processor device, cause the system to:
integrate input data from a plurality of source time-series domains to pretrain a model, the model comprising a set of domain-invariant representations;
fine-tune the pretrained model by learning prompts specific to each source time-series domain using remaining data from the source time-series domains;
apply instance normalization and segment the time-series data into subseries-level normalized patches for the target time-series domain;
feed the normalized patches into a transformer encoder to generate high-dimensional representations of the normalized patches;
utilize a limited number of samples from the target time-series domain to learn the prompt specific to the target domain;
calculate cosine similarity between the prompt of the target domain and the prompts of all source domains to identify a nearest neighbor prompt; and
utilize the nearest neighbor prompt for model prediction in the target time-series domain.

9. The system of claim 8, wherein the pretrained model comprises a PBMN-1 model, and the prompts are concatenated with input time-series data.

10. The system of claim 8, wherein the pretrained model comprises a PBMN-2 model, and the prompts are concatenated with hidden embeddings derived from time-series patches.

11. The system of claim 8, wherein the instance normalization and segmenting the time-series data into patches are performed by an instance normalization operator and a patching module, respectively.

12. The system of claim 8, further comprising generating a high-dimensional representation of the input data by applying self-attention mechanisms within the Transformer encoder.

13. The system of claim 8, wherein the model prediction in the target time-series domain comprises generating forecasts or anomaly detection based on the input data.

14. The system of claim 8, wherein the fine-tuning of the pretrained model involves utilizing backpropagation and gradient descent techniques to optimize parameters of the model.

15. A computer program product for adapting a model trained from multiple source time-series domains to a target time-series domain, the computer program product comprising a computer-readable storage medium having program instructions embodied therewith, the program instructions executable by a hardware processor to cause the hardware processor to:
integrate input data from a plurality of source time-series domains to pretrain a model, the model comprising a set of domain-invariant representations;
fine-tune the pretrained model by learning prompts specific to each source time-series domain using remaining data from the source time-series domains;
apply instance normalization and segment the time-series data into subseries-level normalized patches for the target time-series domain;
feed the normalized patches into a Transformer encoder to generate high-dimensional representations of the normalized patches;
utilize a limited number of samples from the target time-series domain to learn the prompt specific to the target domain;
calculate cosine similarity between the prompt of the target domain and the prompts of all source domains to identify a nearest neighbor prompt; and
utilize the nearest neighbor prompt for model prediction in the target time-series domain.

16. The computer program product of claim 15, wherein the pretrained model comprises a PBMN-1 model, and the prompts are concatenated with input time-series data.

17. The computer program product of claim 15, wherein the pretrained model comprises a PBMN-2 model, and the prompts are concatenated with hidden embeddings derived from time-series patches.

18. The computer program product of claim 15, wherein the instance normalization and segmenting the time-series data into patches are performed by an instance normalization operator and a patching module, respectively.

19. The computer program product of claim 15, further comprising generating a high-dimensional representation of the input data by applying self-attention mechanisms within the Transformer encoder.

20. The computer program product of claim 15, wherein the model prediction in the target time-series domain comprises generating forecasts or anomaly detection based on the input data.
